(19) United States
(12) Patent Application Publication
(10) Pub. No.: US 2017/0222527 A1
(43) Pub. Date: Aug. 3, 2017

(54) Single Phase Motor and Rotor of the Same

(71) Applicant: Johnson Electric S.A., Murten (CH)

(72) Inventors: Yue LI, Hong Kong (CN); Tao ZHANG, Shenzhen (CN); Jie CHAI, Shenzhen (CN); Chui You ZHOU, Shenzhen (CN)

(21) Appl. No.: 15/421,544

(22) Filed: Feb. 1, 2017

(30) Foreign Application Priority Data
Feb. 1, 2016 (CN) 2016 1007 0893.6

(51) Int. Cl. H02K 21/16; H02K 1/14; H02K 19/04; H02K 1/27

(52) U.S. Cl. CPC H02K 21/16; H02K 1/2706; H02K 1/146; H02K 19/04; H02K 2213/03

(57) ABSTRACT

A single phase motor includes a stator and a rotor. The stator includes a stator core. The stator core includes an outer yoke and a plurality of stator teeth. Each stator tooth includes a winding portion and a pole shoe coupled to the winding portion. The rotor includes a rotor core and a plurality of permanent magnets. The permanent magnets are embedded in the rotor core and evenly distributed in the circumferential direction of the rotor core. Each permanent magnet has a stripe-shaped asymmetric structure, and cross-sectional areas at both ends of each permanent magnet are not equal. The initial position of the rotor is able to avoid the dead point position, and the start-up of the motor is stable. The present invention also provides a rotor for the single phase motor.

### CROSS REFERENCE TO RELATED APPLICATIONS

This non-provisional patent application claims priority under 35 U.S.C. §119(a) from Patent Application No. 201610070893.6 filed in The People's Republic of China on Feb. 1, 2016.

### FIELD OF THE INVENTION

The present disclosure relates to the field of motors, more particularly, to a single phase motor and its rotor.

### BACKGROUND OF THE INVENTION

Single phase brushless DC motor has been developed rapidly in recent years, and the structure is generally winding the stator windings on the stator core, which creates a changing magnetic field after powered on, so as to drive the rotors embedded with permanent magnet rotation. As the stator core needs to be wound with stator windings, therefore, slots are usually provided on the stator core for proceeding the process of automatic winding.

However, the existence of the slots increase the magnetic resistance between the part of the stator core where the slot is defined and the rotor permanent magnet, the stator core has starting dead point. That is to say that the magnetic pole axis of the rotor automatically deflects towards a direction in which the magnetic resistance is small when the motor is in a non-energized state or has no significant rotation block, that is, the magnetic pole axis of the rotor deviates from the axial direction of the slots. At this point, the rotor is subjected to zero torque, resulting in motor starting instability.

### SUMMARY OF THE INVENTION

In view of this, the present disclosure is designed to provide a new-typed single phase motor rotor which can improve the starting reliability and a single phase motor using such rotor.

A single phase motor rotor comprises a rotor core and a plurality of permanent magnets. The permanent magnets are embedded in the rotor core and evenly distributed in a circumferential direction of the rotor core. Each permanent magnet has a stripe-shaped asymmetric structure, and cross-sectional areas at both ends of each permanent magnet are not equal.

As a preferred embodiment, a shape of a cross section of each permanent magnet is a shape in which one corner of a rectangular shape is cut away, and a notch is defined in the cut away corner of the permanent magnet.

As a preferred embodiment, the notches are located on the same sides of the magnetic pole axes of the corresponding permanent magnets.

As a preferred embodiment, the notches are rectangular, triangular, right-angle trapezoidal or fan-shaped.

As a preferred embodiment, each permanent magnet has a cross-sectional area of M1 in the axial direction of the rotor, and an area of the notch is M2, wherein 2*M2<M1<5*M2.

As a preferred embodiment, each notch is defined in a side of the corresponding permanent magnet adjacent to an outer circumferential wall of the rotor core.

A single phase motor includes a stator and a rotor as described above. The stator includes a stator core. The stator core includes an outer yoke and a plurality of stator teeth. Each stator tooth includes a winding portion and a pole shoe coupled to the winding portion.

As a preferred embodiment, a uniform air gap is defined between an outer circumferential wall of the rotor core and inner surfaces of the pole shoes, and an axial center of the rotor coincides with an axial center of the stator.

As a preferred embodiment, a slot is defined between adjacent two pole shoes, a minimum circumferential distance of the slot is a, a width of the air gap is b, wherein, b<a<3b.

As a preferred embodiment, a pole-arc coefficient of the rotor is c, wherein, 100°<c<150° electrical angle.

As a preferred embodiment, a starting angle of the motor is between 60° and 90° electrical angle.

As a preferred embodiment, the stator teeth are integrally formed with the outer yoke or the stator teeth are detachably connected to the outer yoke.

As a preferred embodiment, the outer circumferential wall of the rotor core is located on a continuous cylindrical surface, and the permanent magnets are polarized in the radial direction.

In the motor of the present disclosure, the permanent magnet has an asymmetric structure by providing a notch at one end of the permanent magnet, and the reluctances between both ends of the permanent magnet and the stator pole are not equal, so that the initial position of the rotor can avoid the starting dead point of the motor which makes the start-up of the motor more stable, the starting current is small and the starting reliability is good.

### BRIEF DESCRIPTION OF THE DRAWINGS

FIG. 1 is a perspective, schematic view of a stator and a rotor according to a first embodiment of the present disclosure.

FIG. 2 is a top view of the stator and the rotor as shown in FIG. 1.

FIG. 3 is a top view of a stator and a rotor according to another embodiment of the present disclosure.

FIG. 4 is a distribution map of magnetic line of force generated by a rotor under the premise that the existing stator and rotor are in a non-energized state.

FIG. 5 is a distribution map of magnetic line of force generated by the rotor under the premise that the stator and rotor of an embodiment of the present disclosure are in a non-energized state.

FIG. 6 is a cogging torque curve chart of the stator and rotor as shown in FIG. 4.

FIG. 7 is a cogging torque curve chart of the stator and rotor according to an embodiment of the present disclosure.

### DETAILED DESCRIPTION OF THE EMBODIMENTS

More clear and complete descriptions concerning the technical solution of the embodiments of the present invention will now be made with reference to the accompanying drawings of the embodiments of the present disclosure, obviously, the embodiments described hereof are just a partial embodiments of the present invention, rather than all embodiments of the present invention. All other embodiments obtained by those ordinary technicians in the art based on the embodiments of the present invention under the premise of making no contribution of creative work shall belong to the scope of the protection of the present invention.

It's important to note that when a component is referred to as being “fixed” to another component, it may be fixed directly on another component or there may be an intermediate component as well. When a component is identified as being “connected” to another component, it may be directly connected to another component or there may be an intermediate component at the same time. When a component is considered to be “provided on” another component, it may be provided directly on another component or there may be an intermediate component at the same time.

Unless otherwise defined, all technical and scientific terminologies used herein have the same meaning as commonly understood by technicians of the technical field to which the present invention belongs. The terminologies used herein in the descriptions of the present invention are for the purpose of describing particular embodiment only, they are not intended to limit the present invention.

The technical solution and other advantageous effects of the present invention will become apparent from the following detailed description of the preferred embodiments of the present disclosure with reference to the accompanying drawings. The accompanying drawings are provided for the purpose of illustration and description only other than limit the present invention. The dimensions as shown in the accompanying drawings are for convenience of illustration only, they won't limit the proportional relation.

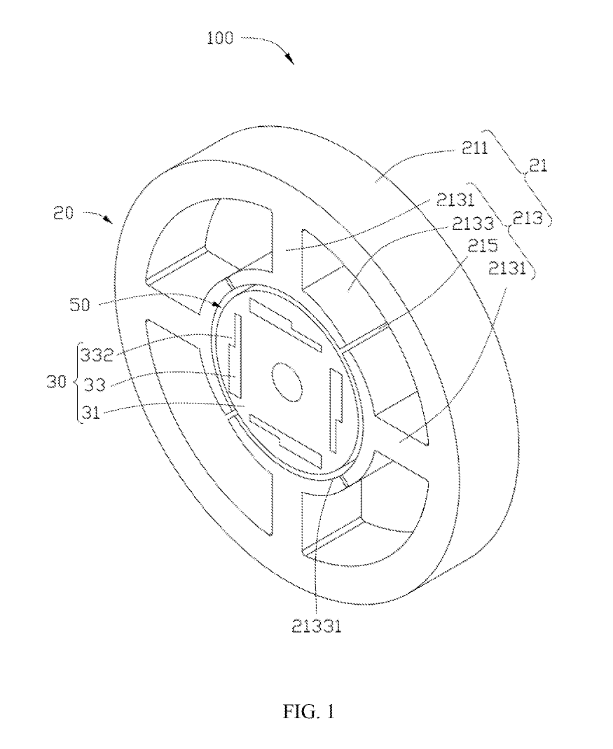

Referring to FIG. 1, a motor 100 according to an embodiment of the present disclosure comprises a stator 20 and a rotor 30 rotatable relatively to the stator 20. The stator 20 comprises a stator core 21, two end caps at both ends of the stator core 21, and a cylindrical casing (not shown). The stator core 21 is mounted on an inner wall of the casing. The two end caps are mounted on both ends of the casing. The rotor 30 is rotatably housed within the stator 20, and both ends of a rotating shaft (not shown) of the rotor 30 are mounted to the end caps through bearings (not shown). Preferably, the motor 100 is a single phase brushless DC motor.

The stator 20 further comprises an insulated wire holder and stator windings (not shown). The insulated wire holder is mounted on the stator core 21 and the stator windings are arranged on corresponding insulated wire holder. The stator core 21 and the stator windings are isolated by the insulated wire holder so as to insulate the stator core 21 and the corresponding stator windings.

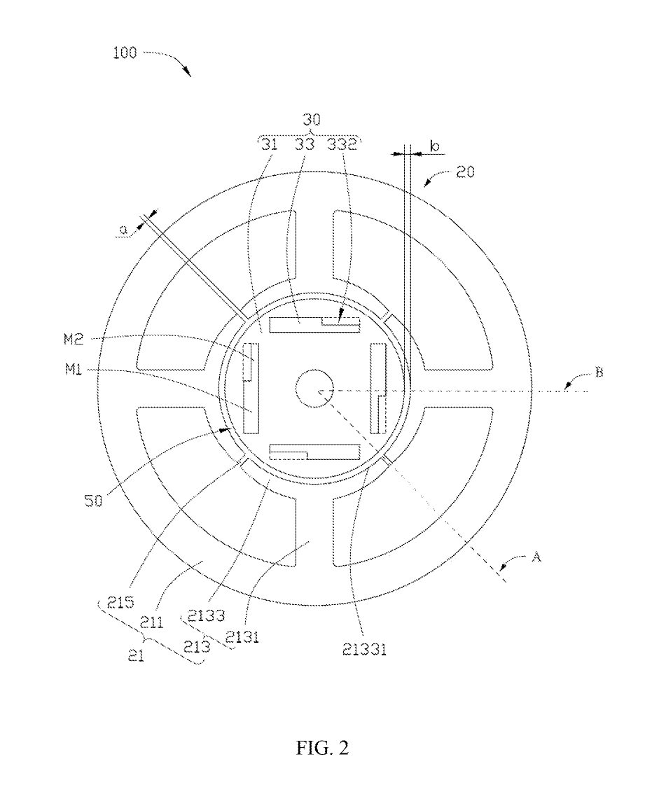

Referring to FIG. 2, the stator core 21 comprises an outer yoke 211 and stator teeth 213. In the present embodiment, the stator core is a four-pole four-slot structure, in which four stator teeth 213 are formed on an inside the outer yoke 211, and four winding slots are defined between the four stator teeth 213. The outer yoke 211 is a closed loop, and it is therefore referred to as an outer ring portion of the stator 20.

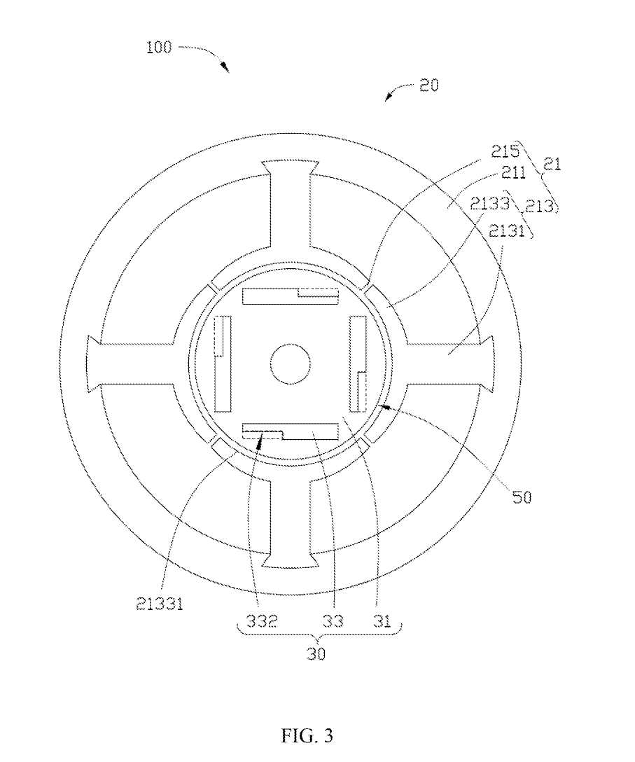

Each of the stator teeth 213 comprises an integrally formed winding portion 2131 and a pole shoe 2133. In the present embodiment, each stator tooth 213 may be formed by extending radially inward from the outer yoke 211. The projection of the winding portion 2131 in the axial direction of the stator core 21 is substantially square. In other embodiments, as shown in FIG. 3, the stator core 21 of the motor 100 may adopt a split type structure, that is, the stator teeth 213 and the outer yoke 211 are detachably connected, the adoption of detachable connection facilitates the winding of the stator winding. The end of the winding portion 2131 away from the corresponding pole shoe 2133 is connected to the inner side of the outer yoke 211 by way of, for example, a dovetail groove embedment.

The pole shoe 2133 is provided on one end of the winding portion 2131, each of the pole shoes 2133 is an arc-shaped structure extending from one end of the winding portion 2133 along the rotor circumferential direction, and the end of each winding portion 2133 away from the outer yoke 211 is connected to the center of the outer circular arc of corresponding pole shoe 2133. In the present embodiment, the four stator teeth 213 are uniformly spaced and mounted inside the outer yoke 211, and the four pole shoes 2133 substantially enclose a circle concentric with the outer yoke 211. Wherein, a slot 215 is defined between adjacent two pole shoes 2133 to prevent leakage of magnetic flux therefrom; in addition, when the structure, as shown in FIG. 2. of an integrated stator core is adopted, the slots 215 is configured to allow the wires for forming the stator windings to pass, so as to wind the stator winding, and the width of the slot 215 is greater than the width of the wires.

In the present embodiment, the pole shoe 2133 comprises a pole arc surface 21331, which is the inner circular arc of the pole shoe 2133. The arc length of the pole arc surface 21331 is close to a quarter of the circumference where the pole arc surface 21331 is located. The plurality of pole arc surfaces 21331 encloses an accommodating space to allow the rotor 30 to be rotatably received therein.

The rotor 30 is an embedded permanent magnet rotor comprising a rotor core 31 and permanent-magnet poles made of a plurality of permanent magnets 33. In the present embodiment, the rotor core 31 is substantially a hollow cylinder, and a rotating shaft (not shown) extends through and is fixed to the rotor core 31. The permanent magnets 33 are strip-shaped permanent magnets 33 embedded in the rotor core 31 along the axial direction of the rotor core 31. In the present embodiment, the number of the permanent-magnet poles is the same as the number of the stator teeth 213, that is, the number of magnetic poles of the stator 20 is the same as the number of magnetic poles of the rotor 30. In the present embodiment, the permanent-magnet poles are polarized in the radial direction of the rotor, the number of the permanent-magnet poles is four and the four permanent-magnet poles are evenly distributed inside the rotor core 31 along the circumferential direction of the rotor core 31. Each of the permanent-magnet poles is formed of one permanent magnet, and of course each of the permanent-magnet poles may be formed of a plurality of permanent magnets.

The rotor 30 is rotatably accommodated in the accommodating space of the stator 20. An air gap 50 is defined between an outer circumferential wall of the rotor core 31 and the pole shoes 2133 so that the rotor 30 is rotatable relative to the stator 20. In the present embodiment, the axis of the rotor 30 coincides with the axis of the stator 20. The air gap 50 is a uniform air gap, that is, all pole arc surfaces 21331 are on the same cylindrical surface, the cylindrical surface is concentric with the rotor, and the distances between the pole arc surfaces 21331 of the pole shoes 2133 and the outer circumferential wall of the rotor core 31 are equal.

One end of each of the permanent magnets 33 defines a notch 332 (dotted line in the drawing) in the axial direction of the rotor core 31. In this embodiment, each notch 332 is provided on a side of the corresponding permanent magnet 33 close to the outer circumferential wall of the rotor core 31. The cross section of the permanent magnet 33 and the cross section of the notch 332 form a rectangular shape as viewed in the axial direction of the rotor 30. The shape of the cross section of the permanent magnet 33 is a shape in which one corner of the rectangular shape is cut away, and the notch 332 is formed at a position where the cut portion is cut. The projected area of the permanent magnet 33 is M1 and the projected area of the notch 332 is M2. In the present embodiment, the projected area of the permanent magnet 33 is greater than twice the area of the notch 332 and less than five times the area of the notch 332. That is, 2*M2<M1<5*M2.

In the present embodiment, each notch 332 is rectangular in the axial direction of the rotor. In other embodiments, the notch 332 may be formed in the shape of a triangle, a right-angle trapezoid or a fan. Each permanent magnet has a stripe-shaped asymmetric structure, and the cross-sectional areas at both ends of each permanent magnet are not equal.

In the present embodiment, the notches 332 are located on the same sides of the magnetic pole axes (broken line B in FIG. 2) of the corresponding permanent magnets 33. Each notch 332 is located at a location where no rotor core is provided, i.e., the location of the notch 332 is air or other non-permeable medium.

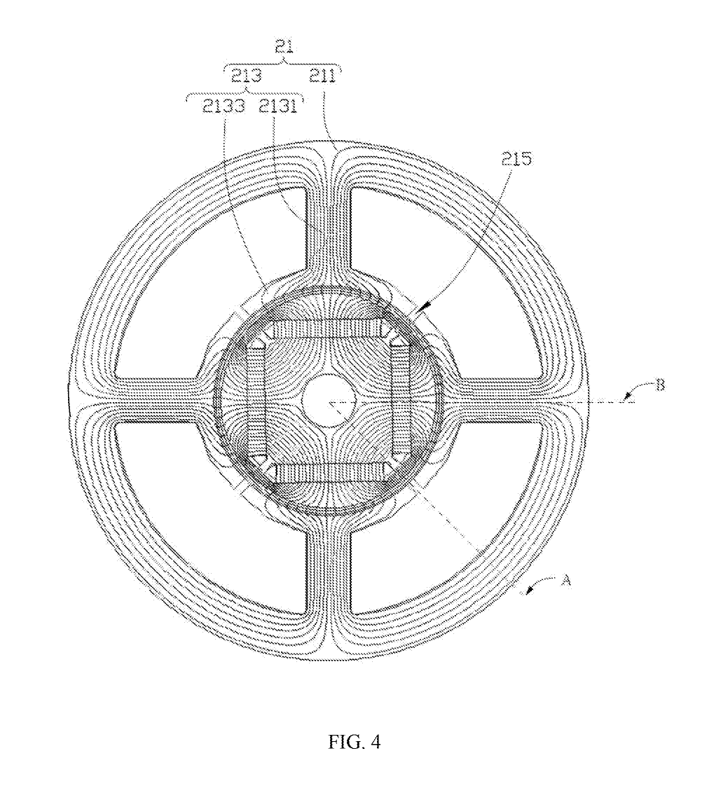

In the field of motor, the so-called Dead Point Position is the position where the torque of the rotor is zero when the stator winding is energized. Please refer to FIG. 4, which is the distribution map of the magnetic line of force under the premise that the motor is in a non-energized state when the projection of the permanent magnet 33 of the existing technology in the axial direction of the rotor 30 is a rectangle. When the motor is in a non-energized state, the center line (broken line A in FIG. 2) of the neutral region of adjacent two permanent magnets 33 is coinciding with the center line of one of the slots 215, i.e., the motor 100 is at the starting dead point position.

The magnetic resistance between the slot 215 and the circumferential wall of the permanent magnet 33 increases due to the existence of the slot 215 while the magnetic resistance between the middle part of the pole arc surface 21331 of the stator 20 and the corresponding permanent magnet 33 is minimum, therefore, each of the permanent magnets 33 rotates automatically to a position where its magnetic pole axis (the broken line B as shown in the drawing) coincides with the center line of one of the pole arc surfaces 21331. That is to say that the center line of the neutral region of the adjacent two permanent magnets 33 coincides with the center line of one of the slots 215, and the rotor 30 of the motor 100 is at the starting dead point position.

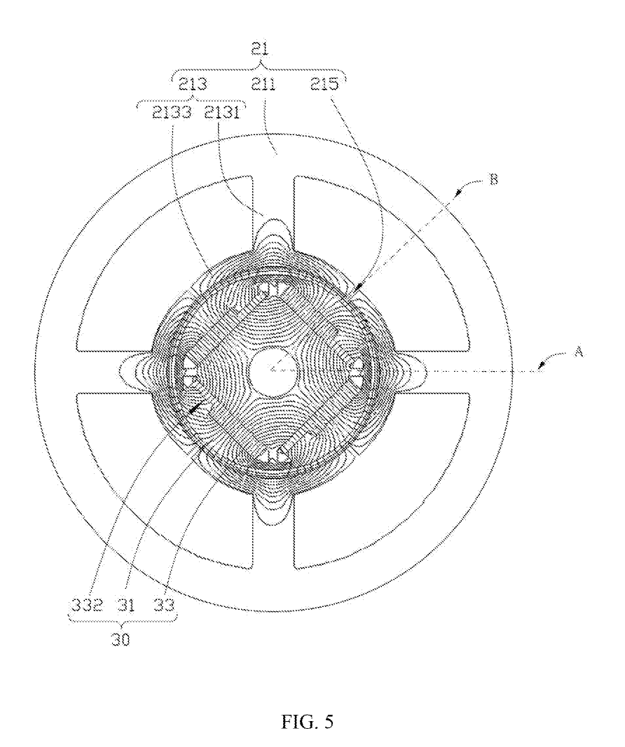

Please refer to FIG. 5, which is the distribution map of magnetic line of force when the motor 100 is in a non-energized state according to an embodiment of the present disclosure. The magnetic resistance between the notch position of the magnetic pole of each permanent magnet 33 and the corresponding pole shoe of the stator is increased due to the presence of the notch 332 (air or other non-permeable medium at the notch). Therefore, the rotor rotates automatically to a position where the magnetic pole axis of each permanent magnet 33 coincides with the center line of one of the slots 215, that is, the magnetic pole axis of the permanent magnet 33 is offset from the center line of the adjacent winding portion 2131 by a certain angle, and the rotor 30 of the motor 100 avoids the starting dead point position. The angle of the magnetic pole axis of the permanent magnet 33 deviated from the center line of the adjacent winding portion 2131 is referred to as a starting angle.

It will be appreciated that depending on the sizes of the plurality of notches 332, the size of the starting angle may vary, that is, the angle of the magnetic pole axis of the permanent magnet 33 deviates from the center line of the winding portion 2131 adjacent thereto may vary. Please refer to FIG. 2 again, for the convenience of illustration, the minimum circumferential distance of each slot 215 is defined as a, the width of the air gap 50 is b. wherein, b<a<3b, that is, the circumferential width a of each slot 215 is greater than the minimum distance b from the outer circumferential wall of the rotor core 31 to the pole arc surface 21331, and is less than three times the minimum distance b from the outer circumferential wall of the rotor core 31 to the pole arc surface 21331.

In the present embodiment, the pole-arc coefficient of the rotor is c, wherein, 100°<c<150° electrical angle, and the starting angle is between 60° and 90° electrical angle.

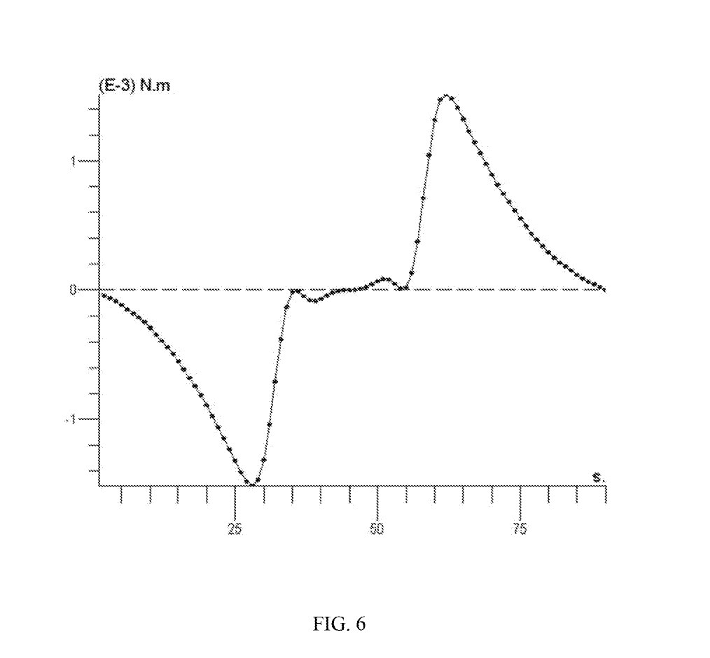

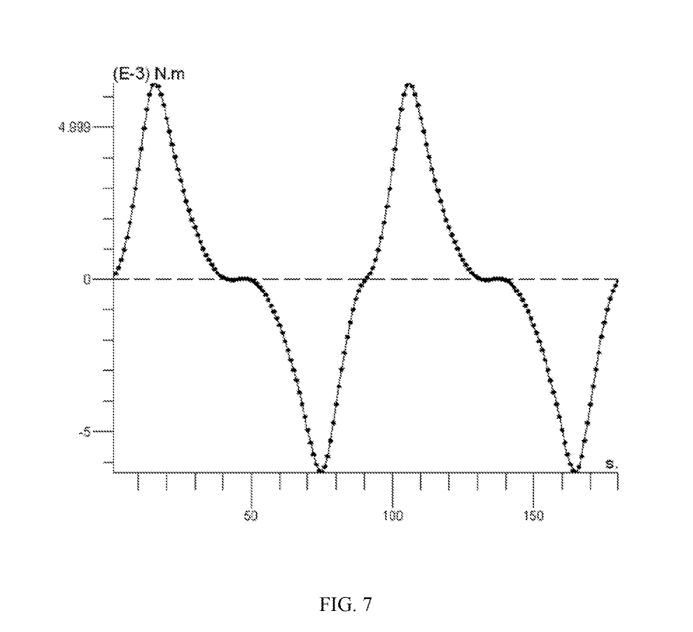

Please refer to FIG. 6 and FIG. 7, FIG. 6 is a cogging torque curve chart of the motor when the motor, of whom, the permanent magnets 33 do not define the notches 332, is as shown in FIG. 4. In FIG. 6, the ordinate is the torque to which the rotor 30 is subjected, and the abscissa is the time of a quarter electric period, wherein the time correspond to the angle at which the center line of the neutral region of two adjacent permanent magnets 33 deviated from the center line of the adjacent slot 215, one second correspond to one degree electrical angle. It can be seen that when the permanent magnets 33 do not define the notches 332, there is a stable point when the center line of the neutral region of the adjacent two permanent magnets 33 coincides with the center line of the adjacent slot 215.

FIG. 7 is a cogging torque curve chart of the motor when the motor, of whom, the permanent magnets 33 define the plurality of notches 332, is as shown in FIG. 5. In FIG. 7, the ordinate is the torque to which the rotor 30 of the present disclosure is subjected, and the abscissa is time of a half electric period, wherein the time correspond to the angle at which the center line of the neutral region of the adjacent two permanent magnets 33 deviated from the center line of the adjacent winding portion 2131, one second correspond to one degree electrical angle. It can be seen that when the permanent magnets 33 define the notches 332, there is a stable point when the center line of the neutral region of the adjacent two permanent magnets 33 coincides with the center line of the adjacent winding portion 2131.

In the present embodiment, the stator core 21 is formed by stacking a plurality of magnetic laminations along an axial direction of the motor 100, and the magnetic laminations are made of soft magnetic material (silicon steel sheet is commonly used in the industry) having magnetic permeability, they may be silicon steel sheet, etc.

In the motor 100 of the present disclosure, a notch 332 is defined in each permanent magnet 33 so that the projected area M2 of each notch 332 in the axial direction of the rotor core 31 and the cross-sectional area M1 of the permanent magnet 33 are 2*M2<M1<5*M2, so that the rotor 30 avoids the start-up dead point of the motor 100 and the start-up of the motor 100 is more stable, the starting current is small and the starting reliability is good.

What described above is a preferable embodiment of the present invention only, rather than any limit to the present invention in any way. For example, the stator core may adopt an integrally formed stator yoke and stator teeth by way of powder metallurgy in addition to the way of lamination as described above. Besides, those skilled in the art may make other variations within the spirit of the present invention. Of course, such variations made in accordance with the spirit of the present invention shall be comprised within the scope of protection of the present invention as claimed.

1. A single phase motor rotor, comprising:
a rotor core; and
a plurality of permanent magnets embedded in the rotor core and evenly distributed in a circumferential direction of the rotor core, wherein each permanent magnet has a stripe-shaped asymmetric structure, and cross-sectional areas at both ends of each permanent magnet are not equal.

2. The single phase motor rotor according to claim 1, wherein a shape of a cross section of each permanent magnet is a shape in which one corner of a rectangular shape is cut away, and a notch is defined in the cut away corner of the permanent magnet.

3. The single phase motor rotor according to claim 2, wherein the notches are located on the same sides of the magnetic pole axes of the corresponding permanent magnets.

4. The single phase motor rotor according to claim 3, wherein the notches are rectangular, triangular, right-angle trapezoidal or fan-shaped.

5. The single phase motor rotor according to claim 2, wherein each permanent magnet has a cross-sectional area of M1 in the axial direction of the rotor, and an area of the notch is M2, wherein 2*M2<M1<5*M2.

6. The single phase motor rotor according to claim 2, wherein each notch is defined in a side of the corresponding permanent magnet adjacent to an outer circumferential wall of the rotor core.

7. A single phase motor, comprising:
a stator comprising a stator core, the stator core comprising an outer yoke and a plurality of stator teeth, each stator tooth comprising a winding portion and a pole shoe coupled to the winding portion; and
a rotor comprising a rotor core and a plurality of permanent magnets, the permanent magnets embedded in the rotor core and evenly distributed in a circumferential direction of the rotor core, wherein each permanent magnet has a stripe-shaped asymmetric structure, and cross-sectional areas at both ends of each permanent magnet are not equal.

8. The single phase motor according to claim 7, wherein a shape of a cross section of each permanent magnet is a shape in which one corner of a rectangular shape is cut away, and a notch is defined in the cut away corner of the permanent magnet.

9. The single phase motor according to claim 8, wherein the notches are located on the same sides of the magnetic pole axes of the corresponding permanent magnets.

10. The single phase motor according to claim 8, wherein each permanent magnet has a cross-sectional area of M1 in the axial direction of the rotor, and an area of the notch is M2, wherein 2*M2<M1<5*M2.

11. The single phase motor according to claim 8, wherein each notch is defined in a side of the corresponding permanent magnet adjacent to an outer circumferential wall of the rotor core.

12. The single phase motor according to claim 8, wherein the notches are rectangular, triangular, right-angle trapezoidal or fan-shaped.

13. The single phase motor according to claim 7, wherein a uniform air gap is defined between an outer circumferential wall of the rotor core and inner surfaces of the pole shoes, and an axial center of the rotor coincides with an axial center of the stator.

14. The single phase motor according to claim 13, wherein a slot is defined between adjacent two pole shoes, a minimum circumferential distance of the slot is a, a width of the air gap is b, wherein, b<a<3b.

15. The single phase motor according to claim 7, wherein a pole-arc coefficient of the rotor is c, wherein, 100°<c<150° electrical angle.

16. The single phase motor according to claim 7, wherein a starting angle of the motor is between 60° and 90° electrical angle.

17. The single phase motor according to claim 7, wherein the stator teeth are integrally formed with the outer yoke or the stator teeth are detachably connected to the outer yoke.

18. The single phase motor according to claim 7, wherein the outer circumferential wall of the rotor core is located on a continuous cylindrical surface, and the permanent magnets are polarized in the radial direction.
